(19) United States
(12) Patent Application Publication
(10) Pub. No.: US 2008/0078672 A1
(43) Pub. Date: Apr. 3, 2008

(54) Hybrid Capacitive Deionization and Electro-Deionization (CDI-EDI) Electrochemical Cell for Fluid Purification

(76) Inventor: Robert D. ATLAS, San Antonio, TX (US)

Correspondence Address: KAMMER BROWNING PLLC, 7700 BROADWAY, SUITE 202, SAN ANTONIO, TX, 78209, US

(21) Appl. No.: 11/864,879

(22) Filed: Sep. 28, 2007

Related U.S. Application Data
(60) Provisional application No. 60/848,446, filed on Sep. 29, 2006.

(51) Int. Cl. B01J 19/08

(52) U.S. Cl. 204/275.1; 204/242

(57) ABSTRACT

Systems and methods are described that combine capacitive deionization (CDI) and electro-deionization (EDI) mechanisms for deionizing aqueous or non-aqueous solutions. The inventive systems and methods modify certain known coatings or films by perforating the films with pin holes and using spacers that separate the coatings from the electrodes. Benefits derived from these improvements include: (a) maintaining a high level of purification; (b) increasing by as much as 25% the rate of expulsion of ions during regeneration; (c) increasing by as much as 50% the rate of electrical discharge of the cell; (d) decreasing the regeneration time (producing as much as 33% more purified water per unit of time); (e) reducing by as much as 25% the power required; and (f) improving the recovery of the system to as much as 85%.

### CROSS REFERENCE TO RELATED APPLICATIONS

This application claims the benefit under Title 35 United States Code § 119(e) of U.S. Provisional Application No. 60/848,446 filed Sep. 29, 2006, the full disclosure of which is incorporated herein by reference.

### BACKGROUND OF THE INVENTION

1. Field of the Invention

The present invention relates generally to fluid purification systems and methods. The present invention relates more specifically to combination capacitive deionization (CDI) and electro-deionization (EDI) systems and associated methods for deionizing aqueous or non-aqueous solutions. The present invention involves the use of flow through capacitors (FTC), capacitive deionization systems, and electro-deionization systems for deionizing aqueous or non-aqueous solutions.

2. Description of the Related Art

Technologies to deionize water include various systems and methods for electro-deionization, which typically utilize a non-porous electrode and a membrane separated from the electrode using a variety of gaskets. On the other hand, other technologies include capacitive deionization and the associated use of a flow through capacitor (FTC) in a charge barrier format. These flow through capacitor based systems rely on a porous electrode with a semi-permeable membrane positioned adjacent to the electrode with virtually no separation between the electrode and membrane.

One disadvantage of electro-deionization systems in general, is that they are typically complex structurally and functionally, often requiring pretreatment to work efficiently. Such systems are normally used as a “polishing” technology, requiring softened water and the prior removal of ions using reverse osmosis as a preferred pretreatment. One disadvantage of the use of a flow through capacitor (FTC) in a charge barrier format is the susceptibility to fouling that such systems often have. This problem occurs because during the regeneration process, the ions can not be fully expelled as a result of becoming trapped in between the electrodes and the membranes.

An example of a primary mass transfer mechanism for technologies involving the type of flow through capacitor systems described above is the FTC device described in U.S. Pat. No. 6,709,560 issued to Andelman, which operates by diffusion through a membrane brought about by an electrical charge density gradient. The system described in Andelman then involves (as a secondary mechanism) absorption onto the electrode during purification. The system described in the above cited U.S. patent issued to Andelman, the full disclosure of which is incorporated herein by reference, provides for flow through capacitors with one or more charge barrier layers. In these FTC devices, ions that are trapped in the pore volume of the flow through capacitors cause inefficiencies as these ions are expelled during the charge cycle into the purification path. In Andelman, a charge barrier layer holds these pore volume ions to one side of a desired flow stream, with the intent of increasing the efficiency with which the flow through capacitor purifies or concentrates ions. During regeneration, however, there is an absence of the charge density gradient and the only mechanism to expel ions is diffusion. Opposite polarity is therefore used to change the charge from negative to positive thus releasing more ions from the surface. This process of expulsion, however, even with systems of the type described in Andelman, can require an extensive period of time.

Technologies characterized as electro-deionization include electro-dialysis and continuous electro-deionization. In general, such nomenclature has traditionally referred to systems that use electrodes to transform electronic current (a flow of electrons) into ionic current (a flow of ions) by oxidation-reduction reactions at the anolyte and catholyte regions of the anodes and cathodes of a cell. In such systems, ionic current is used for deionization in ion-depleting compartments, and neither the anolyte chambers, the catholyte chambers, nor the oxidation-reduction products, participate in the deionization process. In order to avoid contamination and to allow multiple depletion compartments between electrodes, the ion-concentrating and ion-depleting compartments are generally separated from the anolyte and catholyte compartments. To minimize formation of oxidation-reduction products at the electrodes, electro-deionization devices typically comprise multiple layers of ion-concentrating and ion-depleting compartments, bracketed between pairs of end electrodes.

A further disadvantage of many of the existing electro-deionization systems described above involves the energy loss that results from using multiple compartment layers between electrodes, a structure which creates an electrical resistance. Flow through capacitor systems do not generally suffer this problem and further differ from electro-deionization devices in that they purify water without oxidation-reduction reactions. The electrodes in FTC systems electrostatically adsorb and desorb contaminants, so that the electrode (anode and cathode) compartments are directly involved in the deionization process and are typically located within one or both of the ion-depleting and ion-concentrating compartments. The anolyte and catholyte regions are typically contained within a porous electrode structure. Electronic current is generally not transmuted by an oxidation-reduction reaction, as charge is transferred instead by electrostatic adsorption.

Existing FTC systems, however, become energy inefficient at high ion or contaminant concentrations. The flow through capacitor is typically regenerated into the liquid of the feed concentration. When purifying a concentrated liquid, ions are passively brought over into the pores prior to application of a voltage or electric current. Once voltage is applied, these ions are simultaneously adsorbed and expelled during the purification process. Purification can therefore only occur when an excess of feed ions, over and above the pore volume ions, are adsorbed by the electrodes. This establishes a practical limit on the economy of FTC systems, typically in the range of 2500 to 6000 ppm. Seawater, which has ion concentrations of approximately 35,000 ppm, therefore becomes impractical to deionize with FTC systems due to energy inefficiency caused by these pore volume losses.

A further problem associated with both electro-deionization systems and flow through capacitor systems involves the required structure of the membranes utilized. When a membrane material is used in isolation in such systems it must be thicker and have a larger electrical resistance due to the backing material required for its mechanical support. It would be preferable to provide a mechanism for utilizing thinner, more flow efficient membranes that still retain the necessary structural integrity to continue to provide the required surface area within the cell.

It would therefore be desirable to combine the advantages of electro-deionization purification systems with the advantages of flow through capacitor purification systems in a manner that reduces or eliminates the disadvantages of each. Such a combined system could improve the ionic and energy efficiency of flow through capacitors, particularly when treating solutions with high ion concentrations and could facilitate the use of a flow through capacitor to purify solutions with lower energy consumption.

### SUMMARY OF THE INVENTION

The present invention provides a system and a method that combine the advantages of capacitive deionization and electro-deionization. Using a coating of the type described in U.S. Pat. No. 5,936,004 issued to Altmeier, the present invention provides a manner of improving the function of the coating in a hybrid system by perforating the coating with pin holes. The improved system uses spacers to separate the coating from the electrodes in a cell in such a way that a number of operational benefits are achieved. These benefits include: (a) the maintenance of approximately the same level of purification; (b) the provision of as much as a 25% faster expulsion of ions during regeneration; (c) the provision of as much as a 50% faster electrical discharge of the cell; (d) the achievement of a shorter regeneration time thus producing as much as 33% more purified water per unit of time; (e) the requirement of as much as 25% less power; and (f) the allowance for an overall recovery of the system as high as 85%.

U.S. Pat. No. 5,936,004 issued to Altmeier, the full disclosure of which is incorporated herein by reference, describes the manufacture of anion-exchanging molded elements. The goal of Altmeier was to identify anion-exchangers that could be inexpensively produced in a variety of shapes, without the use of carcinogenic chloromethyl ethers. Described in Altmeier are methods whereby halogenated polyethers, preferably epichlorhydrin polymers, can be treated with tertiary amines together with inert polymers to produce such anion-exchanging molded elements by a phase-inversion process or evaporation of the solvent. These molded elements can then be structured (for the purposes of the present invention) in the form of films. The present invention finds improved performance of the types of films described in Altmeier, through the aforementioned processes of perforation and spacing.

In addition to the advantages gained by combining the features described above, the present invention provides improved cell assembly enclosure structures designed to optimize the advantages achieved, as well as improved power source circuitry elements to drive the cell. The combination of all of these improvements provides for a novel electrochemical cell subassembly operable within a novel hybrid capacitive deionization/electro-deionization (CDI/EDI) cell. The improvements, both to the subassembly structure and the cell enclosure structure, further facilitate an efficient manufacturing process for constructing and enclosing the cell.

### BRIEF DESCRIPTION OF THE DRAWINGS

FIG. 1 is a partially schematic cross-sectional view of a hybrid CDI-EDI subassembly of the present invention illustrating the placement of the primary component layers within one example subassembly of the larger cell.

FIG. 2 is a partially schematic cross-sectional view of two subassemblies of the present invention, as shown by example in FIG. 1, connected to a power source.

FIG. 3 is a partial schematic, partial perspective view of a single layer of semi-permeable coating of the present invention shown positioned on the improved electrode structure of the present invention.

FIG. 4 is a partially schematic cross-sectional view of a number of the subassemblies of the present invention stacked and connected in series.

FIG. 5 is a schematic block diagram of the improved power supply system circuitry of the present invention required to make the CDI-EDI device of the present invention operate most efficiently.

FIG. 6 is a perspective view of the bottom half of the cell housing for holding the subassembly systems of the present invention.

FIG. 7 is a perspective view of the top half of the cell housing for holding the subassembly systems of the present invention.

FIGS. 8A & 8B are schematic representations of the typical arrangement of the electrical conductors and the subassemblies of a cell of the present invention, showing the manner of assembly and the manner of connecting each in series to a power supply.

### DETAILED DESCRIPTION OF THE PREFERRED EMBODIMENTS

The combination of a number of improvements over the prior art as described by the present invention, provides for a novel electrochemical cell subassembly operable within a novel hybrid capacitive deionization/electro-deionization (CDI-EDI) cell. These improvements, both to the subassembly structure and the cell enclosure structure, also provide for an efficient manufacturing process for constructing and enclosing the cell. As described above, the present invention provides a manner of improving the function of the coating in the hybrid system by perforating the coating with pin holes and using spacers to separate the coating from the electrodes in the cell.

In the hybrid CDI-EDI cell structure of the present invention, the semi-permeable layers may be constructed as membranes or as coatings. The charge on the coatings is derived for the chemical composition of the polymer used in the formulation of the coating as is known in the art, so as to cause it to be a cation or an anion within the cell.

The coating used in the present invention is thin and 100% polymeric. This results in a low electrical resistance material, as much as 25% less than a membrane using an internal mechanical support spacer. This in turn will typically use as much as 25% less power than similar existing systems.

The RC time constant of the cell electrical characteristics, which was previously thought to dominate the discharge of ions from the surface, is now thought to be in error, because the perforations in the coating now release ions within 10 seconds on average after the charge density gradient is removed. If the RC time constant is low to begin with, then the discharge of ions will happen almost immediately if not blocked from release. This is a difficulty that arises with the operation of the FTC system described in the Andelman Patent referenced above.

The electrode material used in the present invention should be configured with effective characteristics, such as a porous material having optimal properties of surface area, conductance, and capacitance, but does not have to be above 1,800 BET as previously thought. What is more important is the effective BET that is available for mass transfer. Activated carbon, for example, might measure an overall BET of 1,800 but only have 10% of its surface area accessible and wet, making its effective BET is only 180. The present invention uses porous materials that have an effective BET consistently above 70% of the overall BET measured.

From a structural standpoint, when the coating is not in intimate contact with the electrode, there is more room for ions to accumulate, making the ionic efficiency of the device greater. But when the ions have to be expelled, the pin holes help their escape to the surface of the coating when the power source is removed (in other words, when there is no charge density gradient). This results in as much as a 25% faster release of ions from the surface, as much as a 25% faster discharge of the electrical charge, and as much as 33% shorter regenerations times. As a result of the above improvements, as much as 33% more pure water can be produced because there will be more purification cycles per unit time.

The cell housing of the present invention has a dead volume in the flow channel of no more than 25% of the inlet flow. Therefore, if flow is 250 ml per minute the dead volume would not be greater than 65 ml of fluid in the flow channel. This relationship will be of significant benefit when processing fluids with salinities above 1,000 ppm. As the cavity depth of the cells grows large, the ratio of dead volume to flow rate decreases, making the process of flowing from one cell to another in series at higher salinity more efficient.

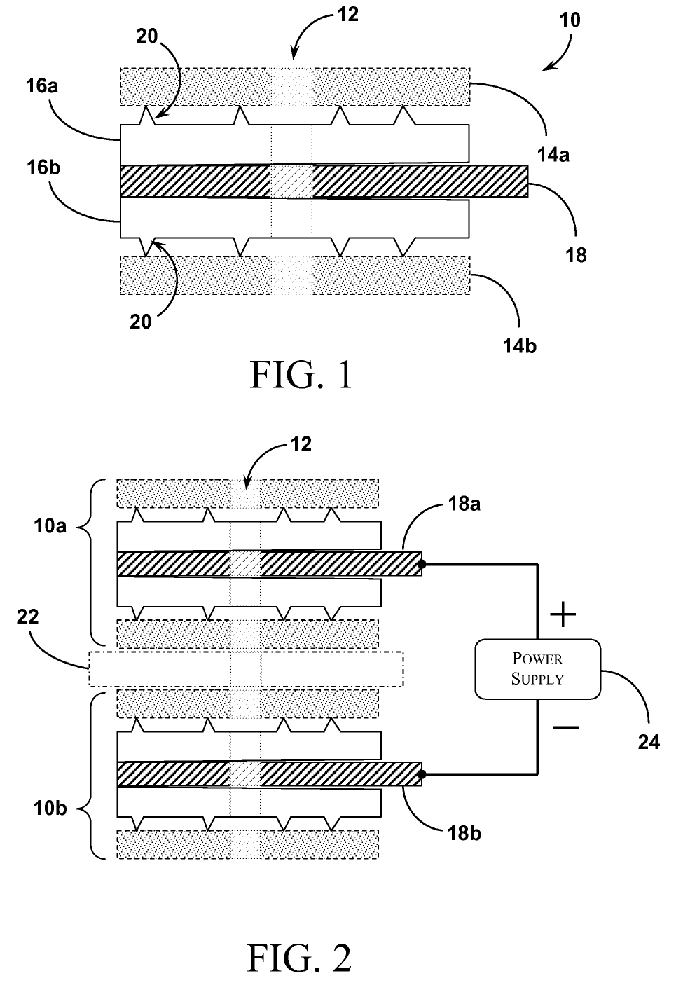

Reference is now made to FIG. 1 for an overview of an individual hybrid CDI-EDI subassembly according to the structural designs of the present invention. In FIG. 1, a typical subassembly 10 is shown illustrating the placement of the porous semi-permeable coating layers 14a and 14b, exterior to the centrally located electrodes 16a and 16b. The coating layers in the preferred embodiment of the present invention may be composed of any of a number of materials such as those referenced in the existing art described above. Preferably these materials are such as to exhibit an inherent positive or negative charge as a result of the material's chemical composition. In the preferred embodiments of the present invention, the coating layers should be generally less than 0.004 inches (4 mils) in thickness. The interior faces of electrodes 16a and 16b are in close electrical contact with conductive element 18. The outside surfaces of electrodes 16a and 16b incorporate “dimples” or small raised projections 20 that serve to set the surface off from the coating layers by approximately 1 mil. The outer surfaces of the coating layers 14a and 14b will generally be positioned next to and against a non-conductive spacer (shown below in FIG. 2). This layered subassembly configuration 10 incorporates a center flow hole (channel) 12 that extends through each of the layers as shown.

FIG. 2 shows two subassemblies 10a and 10b connected to a power supply 24 in a parallel electrical configuration. In this view, subassembly 10a is separated from subassembly 10b by non-conductive spacer 22. Center flow hole (channel) 12 passes through each of the subassemblies 10a and 10b and the non-conductive spacer 22. Conductive elements 18a and 18b extend from the layered components of subassemblies 10a and 10b to power supply 24, as shown, and thereby provide a voltage differential between the two conductive elements. The combination of the two subassemblies shown in FIG. 2 is provided to show the manner in which the charge density gradient is established through the layers of the fully assembled cell. Further subassemblies, layered and electrically connected as described below, would be anticipated in the operational embodiment of the present invention.

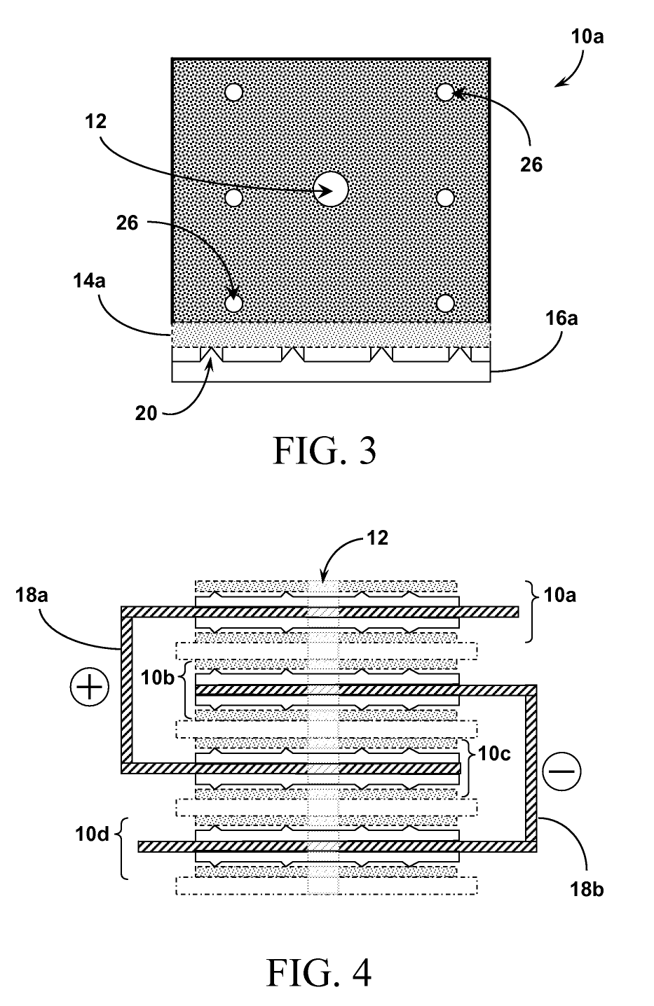

Reference is now made to FIG. 3 for a partial perspective view of two layers of the subassembly 10a showing the perforations 26 positioned in the semi-permeable coating layer 14a which collectively make the coating layer porous. In this manner, the spacing provided by raised projections 20 on electrode 16a allow for increased flow through the semi-permeable coating layer 14a, especially in the regeneration process.

FIG. 4 shows a number of subassemblies 10a-10d stacked and connected in series to the power supply (not shown). Each semi-permeable coating layer (positioned in the same manner described in FIGS. 1 & 2) lies on top of the raised projections on the electrodes which in turn are separated by the non-conductive spacers positioned between the subassemblies. This configuration greatly simplifies the structure of the layered subassemblies and eliminates the need for an additional spacer layer between the semi-permeable coating layers and the electrodes.

Conductor element 18a (the electrically positive element in the configuration shown) extends through subassembly 10a, skips over subassembly 10b, and then extends into subassembly 10c. Conductor element 18b (the electrically negative element in the configuration shown) extends through subassembly 10d, skips over subassembly 10c, and then extends into subassembly 10b. In this manner, the proper voltage gradient is repeatedly established through the alternating sets of electrodes within the overall assembled cell.

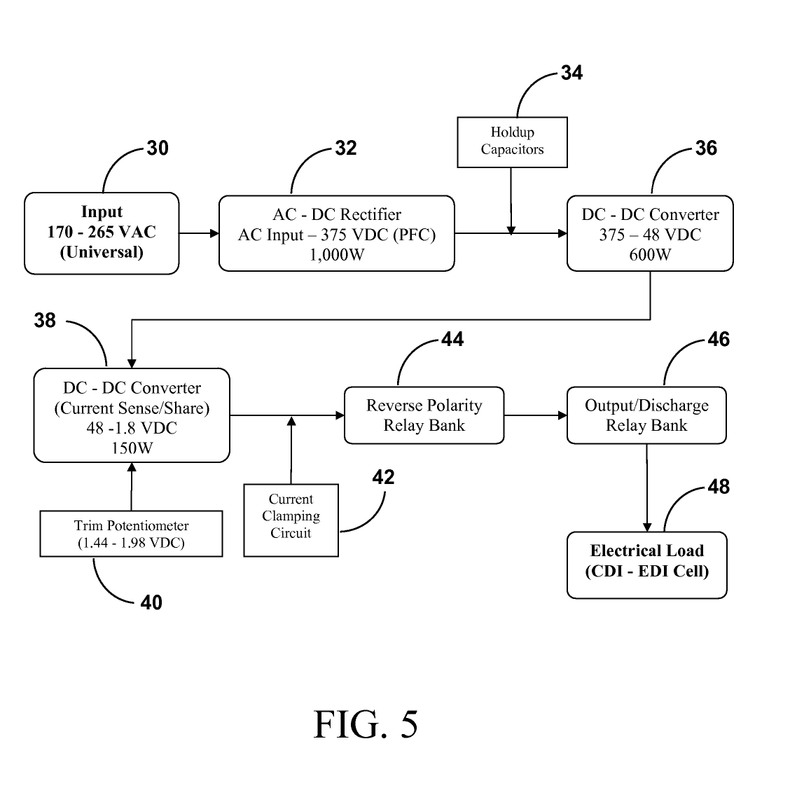

As indicated above, the improved hybrid cell structure of the present invention requires and benefits from a number of improvements to the electronic circuitry used to drive the cell. FIG. 5 shows the power supply circuitry required to drive the hybrid CDI-EDI device of the present invention, delivering negative power to the device during purification and positive power to the device during regeneration, both of which use a lower electrical resistance circuit. The power source input 30 of the circuitry is a universal 170-265 VAC. This input voltage is passed through AC/DC rectifier 32 wherein the AC input is rectified to 375 VDC at 1,000 Watts. Holdup capacitors 34 maintain this voltage as it passes to DC/DC converter 36 where it is stepped down to 48 VDC at 600 Watts. This voltage is then provided to DC/DC converter 38 which is a current sense/share device operating to step the 48 VDC down to 1.8 VDC at 150 Watts. A trim potentiometer 40 allows for varying this voltage from 1.44-1.98 VDC. A current clamping circuit 42 delivers the current from converter 38 to reverse polarity relay bank 44. From relay bank 44 current is finally passed through output/discharge relay bank 46 to the electrical load (the CDI-EDI cell) 48. Operation of the circuitry is carried out according to the described functionality of the circuit components with reverse polarity switched for the cell regeneration processes.

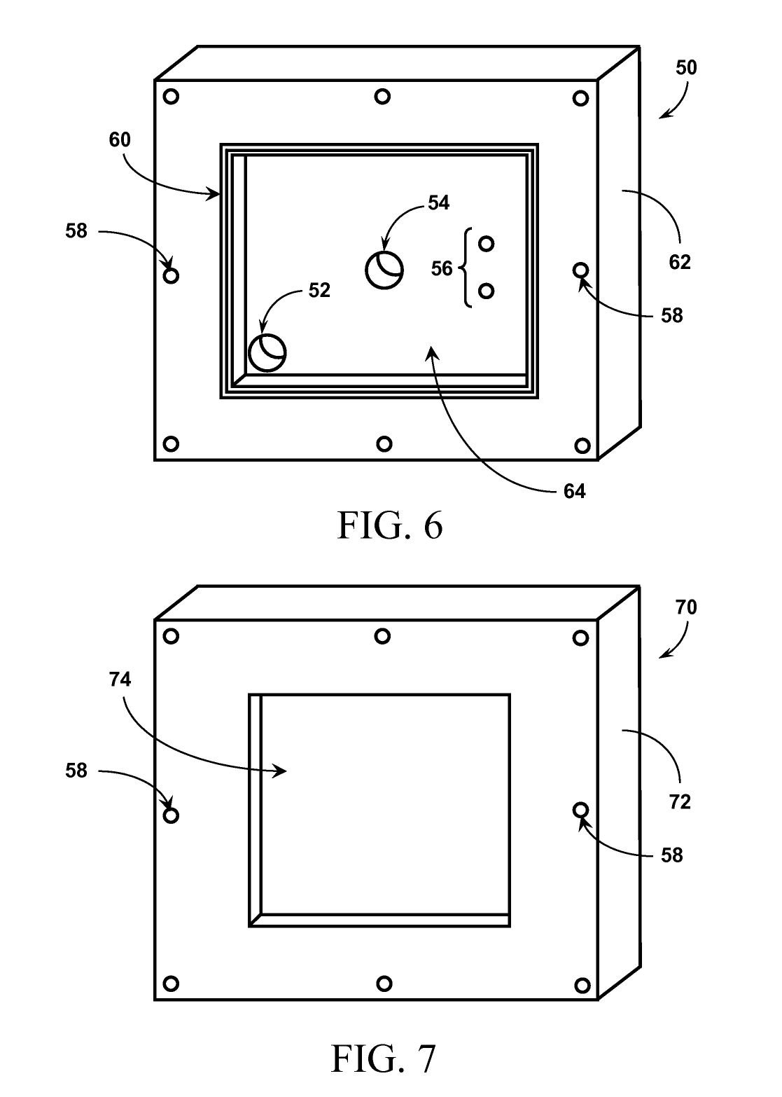

Reference is now made to FIGS. 6 & 7 for a brief description of the improved enclosure structure for containing the cell subassemblies of the present invention. FIG. 6 shows the bottom half 50 of a cell housing that includes a housing body section 62 configured with a plurality of bolt holes 58 suitable for attaching the bottom half of the housing to the top half of the housing. Housing body section 62 defines an inside cavity 64 to hold the subassemblies (not shown but configured as described above). Within inside cavity 64 and extending through the housing body section 62 are inlet flow hole 52, exit flow hole 54, terminal screw holes 56, and a groove for sealing gasket 60 (any effective type of gasket such as EDPM). The overall thickness (depth dimension into the page as shown in FIG. 6) of the bottom half 50 is of course dependent on the thickness (and number) of the subassemblies that are stacked and integrated into the cell assembly.

External to the cell housing components shown in FIGS. 6 & 7 would be positioned a number of ancillary components to facilitate the operation (charge and discharge) of the electrochemical cell. These components, not shown in the drawing figures, include a number of conduits and valve associated with controlling the flow of fluid into and out from the cell housing. In addition, a waste discharge conduit and valve may be positioned external to the cell housing to allow for the expulsion of reject ions that are flushed with feed water from the system during cell regeneration.

The electrically conductive elements shown placed in conjunction with each of the sub-assemblies are connected (typically in parallel series, positive and negative) to terminal conductors (not shown in the drawing figures) that extend through the wall of the cell housing (at the terminal screw holes 56 shown in FIG. 6) to points of electrical connection to the power supply for the cell. Additionally, a number of bolts (or matching bolts and nuts) of appropriate length are positioned in the array of bolt holes 58 that are shown in both FIGS. 6 & 7.

In an assembled manner as described above, the complete hybrid cell of the present invention allows for a flow of ion containing fluid into the cell (through inlet flow hole 52) which leads into an internal void positioned to one side of the stacked subassemblies of the present invention. Fluid flow may then proceed into the cell subassemblies in the space defined by the separation distance between the electrodes and the coatings, and from there into the center flow hole 12 to the outlet low hole 54. During regeneration, the flow is of course reversed and is facilitated by the flow through the perforations in the coating layers as described above.

FIG. 7 shows the top half 70 of a cell housing that aligns with and attaches to the bottom half 50 of the housing as shown in FIG. 6. The top half 70 of the cell housing includes a housing body section 72 with a plurality of housing bolt holes 58 that continue the same bolt holes shown in the bottom half 50 of the housing shown in FIG. 6. The top half 70 of the cell housing further defines inside cavity 74 sized and structured to hold the cell subassemblies and to partially align with the corresponding cavity 64 of the bottom half of the cell enclosure.

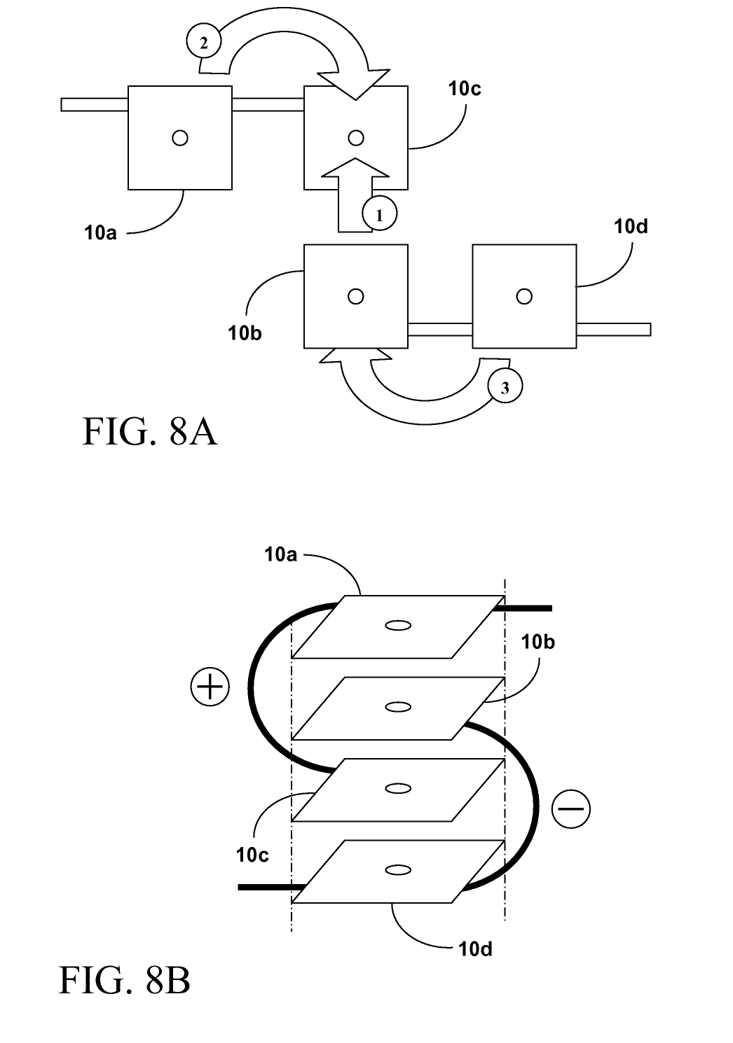

Reference is finally made to FIGS. 8A & 8B which disclose the manner in which the conductors of a specific polarity are connected in series between the respective alternating layered subassemblies. In the view shown in FIG. 8A, the manner of assembling (stacking) the subassemblies so as to alternate the conductor elements is shown. Initially, subassembly 10b is positioned on top of subassembly 10c which is already electrically connected to subassembly 10a. Subassembly 10a is then flipped over onto subassembly 10b in its position on top of subassembly 10c. Finally, subassembly 10d is flipped under and beneath subassembly 10c in its position beneath subassembly 10b. The conductor leads are then connected to a power supply as described above.

FIG. 8B provides a schematic perspective view of the resulting arrangement according to the assembly procedure described above in FIG. 8A. The arrangement shown in FIG. 8B is essentially that shown in schematic cross-section in FIG. 4. In this manner the appropriate charge density gradients are established within the layers of the subassemblies in a continuous fashion. Additional layered subassemblies may be added, if required, by continuing the same alternating polarity electrical connections.

In the manner described, the present invention therefore provides systems and methods for combining features of capacitive deionization (CDI) and electro-deionization (EDI) mechanisms for deionizing aqueous or non-aqueous solutions. Although the present invention has been described in terms of the foregoing preferred embodiments, this description has been provided by way of explanation only, and is not intended to be construed as a limitation of the invention. Those skilled in the art will recognize modifications of the present invention that might accommodate specific environments, structures, and fluid characteristics. Such modifications, as to configuration, where such modifications are coincidental to the type of liquid solution being de-ionized or purified, do not necessarily depart from the spirit and scope of the invention.

I claim:

1. A functional subassembly within an electrochemical cell, the subassembly comprising:
(a) a plurality of carbon electrodes, each of the electrodes having a surface area for ion absorption, each of the electrodes having a capacitance value and a conductance value;
(b) a plurality of semi-permeable porous coatings, each of the porous coatings positioned in fixed spaced relationship to one of the plurality of carbon electrodes, each of the porous coatings perforated with a plurality of pin holes;
(c) at least one electrically conductive member positioned adjacent to and in electrical contact with one or more of the plurality of electrodes; and
(d) at least one electrically non-conductive spacer positioned adjacent to and in physical contact with one or more of the plurality of semi-permeable, porous coatings;
wherein when the subassembly is immersed in a quantity of fluid containing ionic compounds and is subjected to an electric field causing a current density gradient, the ionic compounds are diffused through and captured by the plurality of semi-permeable porous coatings.

2. The subassembly of claim 1 wherein each of the plurality of carbon electrodes further comprise a plurality of raised projections extending from at least one surface thereof, the plurality of raised projections serving to maintain the fixed spaced relationship between the carbon electrodes and the porous coatings.

3. The subassembly of claim 2 wherein the plurality of raised projections each extend approximately 0.001 inches from the overall surface of the carbon electrode.

4. The subassembly of claim 1 wherein the plurality of semi-permeable porous coatings each comprise layers approximately 0.004 inches thick.

5. The subassembly of claim 1 wherein the plurality of semi-permeable porous coatings each comprise materials whose chemical composition provides an inherent positive or negative charge on the coatings.

6. The subassembly of claim 5 wherein at least one of the plurality of semi-permeable porous coatings comprises a positively charged material (a cation) and is electrically connected to a positive terminal of a DC power supply, the DC power supply providing a voltage differential for driving the electrochemical cell.

7. The subassembly of claim 5 wherein at least one of the plurality of semi-permeable porous coatings comprises a negatively charged material (an anion) and is electrically connected to a negative terminal of a DC power supply, the DC power supply providing a voltage differential for driving the electrochemical cell.

8. The subassembly of claim 1 wherein the plurality of carbon electrodes comprises at least one anode and at least one cathode.

9. The subassembly of claim 6 wherein the at least one of the plurality of semi-permeable porous coatings comprises a plurality of positively charged coatings (cations), the at least one electrically conductive member comprises a plurality of conductive members each positioned adjacent to and in electrical contact with at least one of the plurality of positively charged coatings (cations), and the plurality of conductive members in contact with the cation coatings are electrically connected together with a cation conductive lead.

10. The subassembly of claim 7 wherein the at least one of the plurality of semi-permeable porous coatings comprises a plurality of negatively charged coatings (anions), the at least one electrically conductive member comprises a plurality of conductive members each positioned adjacent to and in electrical contact with at least one of the plurality of negatively charged coatings (anions), and the plurality of conductive members in contact with the anion coatings are electrically connected together with an anion conductive lead.

11. The subassembly of claim 9 wherein the at least one of the plurality of semi-permeable porous coatings further comprises a plurality of negatively charged coatings (anions), the at least one electrically conductive member further comprises a plurality of conductive members each positioned adjacent to and in electrical contact with at least one of the plurality of negatively charged coatings (anions), and the plurality of conductive members in contact with the anion coatings are electrically connected together with an anion conductive lead.

12. The subassembly of claim 11 wherein the cation conductive lead is electrically connected to a positive terminal of a DC power supply and the anion conductive lead is electrically connected to a negative terminal of a DC power supply.

13. The subassembly of claim 12 further comprising means for reversing the polarity of the cation and anion conductive leads across the terminals of the DC power supply, the reversal effecting a discharge of the ionic compounds from the plurality of semi-permeable porous coatings.

14. The subassembly of claim 1 wherein the plurality of electrodes, the plurality of semi-permeable coatings, the at least one electrically conductive member, and the at least one electrically non-conductive member, each define a coaxially aligned centralized flow aperture extending there through.

15. A CDI-EDI hybrid electrochemical cell for de-ionizing a fluid, the hybrid cell comprising:
(a) a plurality of functional subassemblies, each of the subassemblies comprising:
(i) a plurality of carbon electrodes, each of the electrodes having a surface area for ion absorption, each of the electrodes having a capacitance value and a conductance value;
(ii) a plurality of semi-permeable porous coatings, each of the porous coatings positioned in fixed spaced relationship to one of the plurality of carbon electrodes, each of the porous coatings perforated with a plurality of pin holes;
(iii) at least one electrically conductive member positioned adjacent to and in electrical contact with one or more of the plurality of electrodes; and
(iv) at least one electrically non-conductive spacer positioned adjacent to and in physical contact with one or more of the plurality of semi-permeable, porous coatings;
(b) a cell housing, the housing surrounding and containing the plurality of functional subassemblies, the housing defining a fluid inlet and a fluid outlet;
(c) at least one pair of electrical conductors extending through the cell housing from a position internal to the housing to a position external to the housing, the at least one pair of electrical conductors connected to the at least one electrically conductive members of the plurality of functional subassemblies; and
(d) a DC power supply connected to the at least one pair of electrical conductors.

16. The hybrid electrochemical cell of claim 15 wherein the plurality of electrodes, the plurality of semi-permeable coatings, the at least one electrically conductive member, and the at least one electrically non-conductive member, of each of the plurality of functional assemblies, each define a coaxially aligned centralized flow aperture extending there through, and the fluid inlet of the cell housing is in fluid conduction with the centralized flow aperture.

17. The hybrid electrochemical cell of claim 15 wherein the fluid inlet and the fluid outlet of the housing each further comprise a valve for alternately allowing or interrupting a flow of the fluid into and out of the housing.

18. The hybrid electrochemical cell of claim 17 wherein the valve of at least one of the fluid inlet or the fluid outlet comprises a variable flow valve for controlling and altering a flow rate of the fluid through the electrochemical cell.

19. The hybrid electrochemical cell of claim 15 further comprising means for reversing the polarity of the connection between the at least one pair of electrical conductors and the DC power supply, a first connection state serving to diffuse ions in the fluid through the semi-permeable porous coatings, thereby capturing the ions therein, and a second reverse connection state serving to discharge the ions from the semi-permeable porous coatings, thereby regenerating the electrochemical cell.

20. The hybrid electrochemical cell of claim 15 wherein the plurality of carbon electrodes each comprise a material selected from a group consisting of activated carbon powder and carbon black.

21. The hybrid electrochemical cell of claim 15 wherein the cell housing comprises a first housing component and a second housing component, the two housing components separable to allow the insertion of the plurality of functional subassemblies into the cell housing, the cell housing further comprising a gasket for sealing a mating surface between the two housing components, the cell housing further comprising attachment means for securing the first housing component to the second housing component.

22. The hybrid electrochemical cell of claim 15 wherein the DC power supply has a capacity to deliver 1.5 watts of power per gram of electrode.

23. The hybrid electrochemical cell of claim 15 wherein the cell housing further comprises a waste discharge valve that allows an expulsion of discharged ions flushed from the cell with discharge fluid during regeneration of the cell.
